(19) United States
(12) Patent Application Publication
(10) Pub. No.: US 2026/0063163 A1
(43) Pub. Date: Mar. 5, 2026

(54) BOLTING SYSTEM WITH LOOSENING DETECTION FUNCTION

(71) Applicant: HWASUNG FASTENERS Co., Ltd., Yangsan-si (KR)

(72) Inventor: Il-bong WON, Yangsan-si (KR)

(21) Appl. No.: 18/819,662

(22) Filed: Aug. 29, 2024

(51) Int. Cl. F16B 39/24; F16B 31/02

(52) U.S. Cl. CPC F16B 39/24; F16B 31/028

(57) ABSTRACT

A bolting system with a loosening detection function includes: a bolt body in the form of a stud bolt which is inserted into a workpiece; nuts screw-screwed to both ends of the bolt body to fasten the workpiece; and a sensor module positioned between the nut and the workpiece to detect bolting information including fastening pressure and fastening position of the nuts, wherein the sensor module has a small battery embedded for power supply and is configured to perform pairing (wireless communication) with a control unit including a terminal and a server by a communication module.

### TECHNICAL FIELD

The present invention relates to a bolting system with a loosening detection function which can effectively detect the loosening phenomenon between a bolt and a nut exerting fastening force by screw-coupling.

### BACKGROUND OF INVENTION

In general, bolts and nuts are widely used as fastening means. Due to the characteristic of nuts being screw-coupled to male screws part of bolts, when the bolts and the nuts are exposed to external vibration or shock, it causes loosening of the nuts, which adversely affects a workpiece.

Accordingly, to prevent loosening of a bolt and a nut, measures such as the use of a spring washer or the fastening of double nuts have been taken. However, loosening of a bolt and a nut still frequently occurs due to various unforeseen causes.

Korean Patent No. 10-1537748 which is a conventional art discloses a technology for sensing a coupling state, comprising: a bolt having a bar with threads and a head formed at one end of the bar; a nut screw-coupled with the bar of the bolt; a washer interposed between the bolt and the nut; and a light sensing part including a light emitting part fixed to one side of the head of the bolt and emitting light and a light receiving part fixed on one side of the washer to receive the light emitted from the light emitting part, wherein the light receiving part is attached and fixed on the washer such that the light receiving part can be aligned in a straight line with the light emitting part after the bolt and the nut are fastened.

Additionally, Korean Patent No. 10-1168324 which is another conventional art discloses a detection device, which enhances the reliability of fastening of a bolt and a nut by detecting the loosening of the bolt and the nut, comprising: a nut cap, which has a magnet attached on the internal surface of the nut cap and moving according to the loosening of the nut; a lead switch, of which one end of a lead is magnetized into N pole and the other end of the lead is magnetized into S pole so that a contact point of the lead switch is in the ON-state due to a pulling power of the lead when the magnet is moved by the loosening of the nut; and a communication module which transmits a communication module identifier to a user terminal through a wireless communication when the contact point of the lead switch is in the ON-state.

### DETAILED DESCRIPTION OF THE INVENTION

### Problems to be Solved

Such conventional arts aim to detect the loosening of bolts and nuts more quickly and accurately, but have several disadvantages in that it is difficult to apply and manage the technologies to all of the bolts and the nuts mounted in large quantity to a structure including modular bridges due to a complex structure, and in that it is impossible to numerically measure and monitor the loosening status of the bolts and the nuts.

### Solution to Solve the Problems

Accordingly, the present invention has been made to solve the above-mentioned problems occurring in the prior arts, and it is an objective of the present invention to provide a bolting system with a loosening detection function, which is improved in structure to output a loosening distance or a fastening force of a nut through displacement (distance, and pressure) values detected by a sensor module, thereby allowing anyone to intuitively realize the loosening status of the nut and respond to the loosening status in real-time.

To accomplish the above objective, according to the present invention, there is provided a bolting system with a loosening detection function including: a bolt body in the form of a stud bolt which is inserted into a workpiece; nuts screw-screwed to both ends of the bolt body to fasten the workpiece; and a sensor module positioned between the nut and the workpiece to detect bolting information including fastening pressure and fastening position of the nuts, wherein the sensor module has a small battery embedded for power supply and is configured to perform pairing (wireless communication) with a control unit including a terminal and a server by a communication module.

In another aspect of the present invention, there is provided a bolting system with a loosening detection function including: a bolt body inserted into a workpiece and having a bolt head formed at one end thereof; nuts screw-screwed to both ends of the bolt body to fasten the workpiece; and a sensor module positioned between the bolt head and the workpiece and between the nut and the workpiece to detect bolting information including fastening pressure and fastening position of the bolt head and the nuts, wherein the sensor module has a small battery embedded for power supply and is configured to perform pairing (wireless communication) with a control unit including a terminal and a server by a communication module.

Moreover, the sensor module includes: a first sensor module which detects positional movement due to the loosening of one or more of the bolt body and the nut; and a second sensor module which detects vibration or pressure applied to one or more of the bolt body and the nut, wherein the first sensor module is configured to set the initial position firmly fastened to the workpiece by the bolt body and the nut as the zero point, and based on the zero point, detects positional movement values according to the loosening of the one or more of the bolt body and the nut, thereby numerically calculating and visually outputting the loosening distance of the bolt body and the nut.

In this instance, the second sensor module is provided to be finely adjusted in installation pressure by a pressure setting module. The pressure setting module includes: a pressure chamber which is formed to penetrate through the bolt head or the nut in the longitudinal direction of the bolt body and has a female screw formed on the inner circumferential surface thereof; and an adjustment bolt which is inserted into the pressure chamber and screw-coupled to the female screw to facilitate pitch transfer. After the bolt body and the nut are coupled to the workpiece, when the second sensor module is inserted into the pressure chamber and the adjustment bolt is screw-coupled into the pressure chamber, the second sensor module is pressed towards the workpiece by the pitch transfer of the adjustment bolt, so the initial zero-point pressure is finely adjusted.

In addition, the sensor module is inserted into a sensing washer positioned between the nut and the workpiece or between the bolt head and the workpiece, and the sensing washer is configured to be in surface contact with the outer peripheral surface of the bolt head or the nut by a locking piece formed on the outer peripheral surface thereof such that the sensing washer is restrained to rotate together with the bolt head or the nut.

According to the specific means for solving the above-mentioned problems, the bolting system with a loosening detection function according to the present invention has an improved structure to numerically calculate and output the loosening distance of the nut by matching vibration or pressure detection values and positional movement displacement values detected by the sensor module, thereby allowing anyone to intuitively realize the loosening status of the nut and respond to the loosening status in real-time.

### BRIEF DESCRIPTION OF THE DRAWINGS

FIG. 1 is an exploded and assembled view of a bolting system with a loosening detection function according to a preferred embodiment of the present invention.

FIG. 2 is an exploded and assembled view of a bolting system with a loosening detection function according to another preferred embodiment of the present invention.

FIG. 3 is a configuration diagram illustrating insertion holes of the bolting system with a loosening detection function according to an embodiment of the present invention.

FIG. 4 is a configuration diagram illustrating a sensing washer of the bolting system with a loosening detection function according to the present invention.

FIG. 5 is a configuration diagram illustrating a pressure setting module of the bolting system with a loosening detection function according to the present invention.

### EMBODIMENTS

Hereinafter, the present invention will be described in more detail below with reference to specific embodiments illustrated in the attached drawings. The technical terms used in the present specification are selected considering the functionalities in the embodiments, and the meanings of the terms may vary according to the specific embodiments of the present invention. The directional terms such as “up, down, front, and rear” used in the following description are defined based on the drawings, and shapes and positions of components are not limited by the terms.

The present invention relates to a bolting system with a loosening detection function which is improved in a structure to numerically calculate and output a loosening distance of a nut by matching vibration or pressure detection values and positional movement displacement values detected by a sensor module, thereby allowing a user to intuitively realize the loosening status of the nut. The bolting system includes a bolt body 10, a nut 20, and a sensor module 30. Hereinafter, each component will be described in detail.

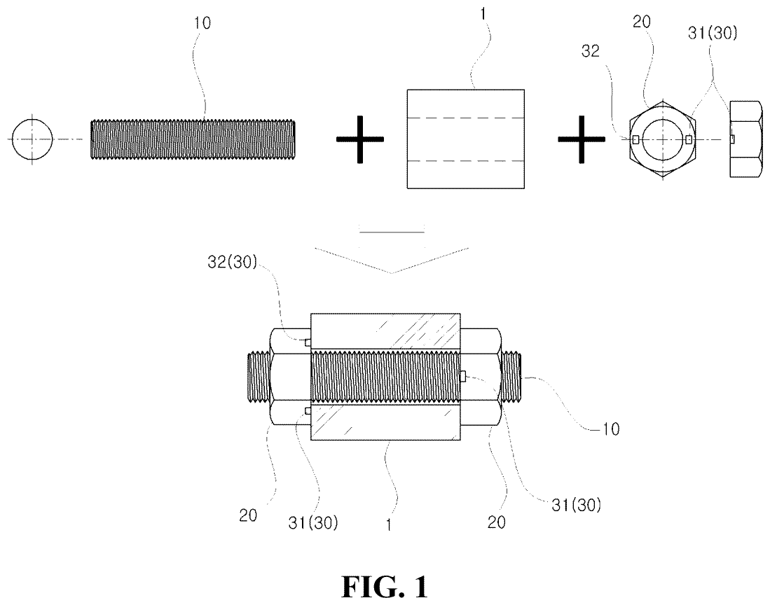

FIG. 1 is an exploded and assembled view of a bolting system with a loosening detection function according to a preferred embodiment of the present invention.

FIG. 1 illustrates a bolting system in which a plurality of nuts are coupled to a stud bolt. That is, the bolting system includes: a bolt body 10 in the form of a stud bolt which is inserted into a workpiece 1; nuts 20 screw-screwed to both ends of the bolt body 10 to fasten the workpiece 1; and a sensor module 30 positioned between the nut 20 and the workpiece 1 to detect bolting information including fastening pressure and fastening position of the nuts 20.

The bolt body 10 is a stud bolt with no bolt head and is inserted into the workpiece 1, and then, a pair of the nuts 20 are fastened to both ends of the bolt body.

Moreover, the sensor module 30 is provided onto the nuts 20 fastened to the bolt body 10. The sensor module 30 has a small battery embedded for power supply and is configured to perform pairing (wireless communication) with a control unit including a terminal and a server by a communication module.

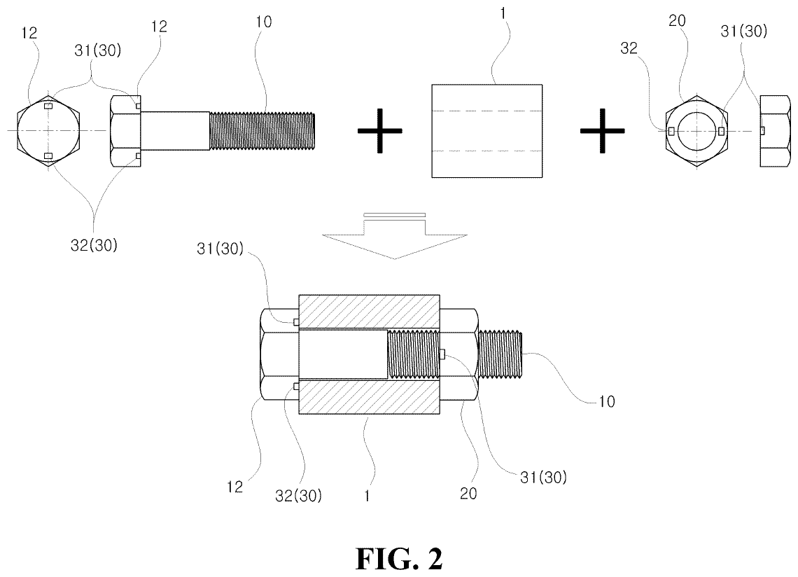

FIG. 2 is an exploded and assembled view of a bolting system with a loosening detection function according to another preferred embodiment of the present invention.

The bolting system with a loosening detection function according to the embodiment in FIG. 2 includes: a bolt body 10 which is inserted into a workpiece 1 and has a bolt head 12 formed at one end thereof; a nut 20 which is screw-coupled to the bolt body 10 to fasten the workpiece 1; and a sensor module 30 which is arranged between the bolt head 12 and the workpiece 1 and between the nut 20 and the workpiece 1 to detect bolting information including fastening pressure and fastening position of the bolt head 12 and the nut 20.

That is, the bolt body 10 is inserted into the workpiece 1, and the nut 20 is coupled to one end of the bolt body 10 to fasten the workpiece 1.

Additionally, the sensor module 30 includes a small battery embedded for power supply, and is connected with a control unit including a terminal and a server through pairing by a communication module.

The sensor module 30 for detecting bolting information may include: a first sensor module 31 which detects positional movement due to the loosening of one or more of the bolt body 10 and the nut 20; and a second sensor module 32 which detects vibration or pressure applied to one or more of the bolt body 10 and the nut 20.

Here, the first sensor module 31 is configured to set the initial position firmly fastened to the workpiece 1 by the bolt body 10 and the nut 20 as the zero point, and based on the zero point, detects positional movement values according to the loosening of the one or more of the bolt body 10 and the nut 20.

Furthermore, the sensor module is configured to numerically calculate the loosening distance of the bolt body 10 and the nut 20 using the positional movement value detected through the first sensor module 31 and visually output the calculated results to a console or the terminal of the control unit, thereby allowing anyone to easily and intuitively realize the loosening status in real-time for rapid response.

Meanwhile, when the second sensor module 32 capable of detecting pressure is applied, the sensor module can measure the fastening pressure between the bolt head 12, the nut 20, and the workpiece to indicate the start of loosening when a measured value falls below an initial set value and provide an audiovisual alarm when the measured value drops below a preset value, thereby preventing potential loosening in advance.

Furthermore, the sensor module can calculate vibration or pressure values under conditions that cause loosening of the bolt body 10 and the nut 20 by matching the vibration or pressure detection values of the second sensor module 32 with the positional movement displacement values due to the loosening of the first sensor module 31, and predict the loosening of the bolt body 10 and the nut 20 based on the vibration or pressure detection values of the second sensor module 32.

As described above, the bolting system can predict a decrease in fastening force of the workpiece 1 by monitoring and utilizing the loosening distance values detected by the first sensor module 31 and the vibration or pressure detection values of the second sensor module 32, thereby pre-emptively preventing the decrease in fastening force.

Moreover, the bolting system can accurately calculate the inspection cycle based on the detection data from the first and second sensor modules 31 and 32, and improve the structural safety by reflecting the measurement results to the design of the workpiece 1.

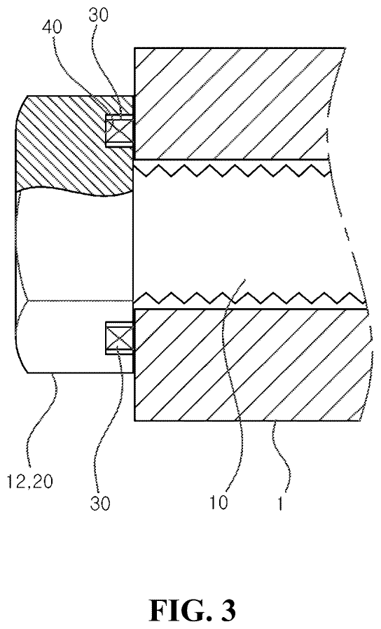

FIG. 3 is a configuration diagram illustrating insertion holes of the bolting system with a loosening detection function according to an embodiment of the present invention. The sensor module 30 is configured to be inserted into the insertion hole 40 formed in the nut 20 or the bolt head 12.

That is, the insertion hole 40 is recessed on one face of the nut 20 or the bolt head 12 facing the workpiece 1. In this instance, the insertion holes 40 are spaced at regular intervals to accommodate the first and second sensor modules 31 and 32 in separate spaces.

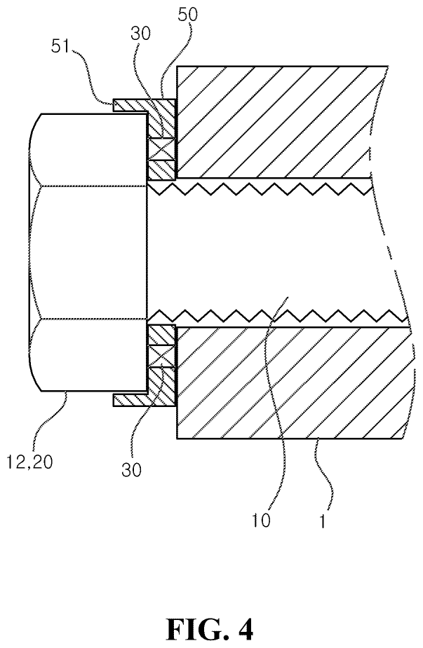

FIG. 4 is a configuration diagram illustrating a sensing washer of the bolting system with a loosening detection function according to the present invention. The sensor module 30 can be inserted into a sensing washer 50 positioned between the nut 20 and the workpiece 1 or between the bolt head 12 and the workpiece 1.

That is, the plurality of insertion holes are formed through the sensing washer 50, and the first and second sensor modules of the sensor module 30 are inserted into the insertion holes.

Furthermore, the sensing washer 50 is configured to be in surface contact with the outer peripheral surface of the bolt head 12 or the nut 20 by a locking piece 51 formed on the outer peripheral surface thereof such that the sensing washer 50 is restrained to rotate together with the bolt head 12 or the nut 20.

As described above, the sensing washer 50 is configured to rotate in conjunction with the positional movement according to the loosening of the bolt head 12 or the nut 20, allowing the first sensor module 31 to move with the sensing washer 50 and detect the positional movement displacement values or pressure displacement value of the bolt head 12 and the nut 20.

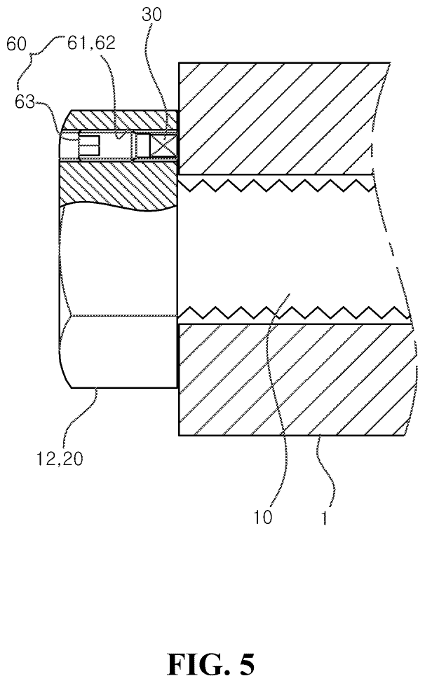

FIG. 5 is a configuration diagram illustrating a pressure setting module of the bolting system with a loosening detection function according to the present invention. The second sensor module 32 is configured to be accurately adjusted in installation pressure by a pressure setting module 60.

In detail, the pressure setting module 60 includes: a pressure chamber 62 which is formed to penetrate through the bolt head 12 or the nut 20 in the longitudinal direction of the bolt body 10 and has a female screw 61 formed on the inner circumferential surface thereof; and an adjustment bolt 63 which is inserted into the pressure chamber 62 and screw-coupled to the female screw 61 to facilitate pitch transfer.

Now, a use condition will be described. As illustrated in FIG. 5, after the bolt body 10 and the nut 20 are coupled to the workpiece 1, when the second sensor module 32 is inserted into the pressure chamber 62 and the adjustment bolt 63 is screw-coupled into the pressure chamber 62, the second sensor module 32 is pressed towards the workpiece 1 by the pitch transfer of the adjustment bolt 63, so the initial zero-point pressure is finely adjusted.

As described above, since the adjustment bolt 63 can adjust initial zero-point pressure of the second sensor 32 simply and finely, even if the surface of the workpiece 1 which is pressed by the bolt head 12 or the nut 20 is formed ununiformly, reliability in pressure detection by the second sensor 32 can be secured.

As described above, while the detailed description of the present invention has focused on the most preferred embodiment of the present invention, it would be understood that various modifications and changes within the scope of the present invention are also possible without departing from the technical scope of the present invention. Therefore, it would be also understood that the protective scope of the present invention should not be limited to the embodiments described herein but should extend to the technologies described in the following claims and to equivalents of the technologies.

What is claimed is:

1. A bolting system with a loosening detection function, comprising:
a bolt body in the form of a stud bolt which is inserted into a workpiece;
nuts screw-screwed to both ends of the bolt body to fasten the workpiece; and
a sensor module positioned between the nut and the workpiece to detect bolting information including fastening pressure and fastening position of the nuts,
wherein the sensor module has a small battery embedded for power supply and is configured to perform pairing (wireless communication) with a control unit including a terminal and a server by a communication module.

2. The bolting system according to claim 1, wherein the sensor module comprises:
a first sensor module which detects positional movement due to the loosening of one or more of the bolt body and the nut; and
a second sensor module which detects vibration or pressure applied to one or more of the bolt body and the nut,
wherein the first sensor module is configured to set the initial position firmly fastened to the workpiece by the bolt body and the nut as the zero point, and based on the zero point, detects positional movement values according to the loosening of the one or more of the bolt body and the nut, thereby numerically calculating and visually outputting the loosening distance of the bolt body and the nut.

3. The bolting system according to claim 2,
wherein the sensor module calculates vibration or pressure values under conditions that cause loosening of the bolt body and the nut by matching the second sensor module's vibration or pressure detection values with the first sensor module's positional movement displacement values due to the loosening,
wherein the sensor module predicts the loosening of the bolt body and the nut based on the vibration or pressure detection values of the second sensor module.

4. The bolting system according to claim 2,
wherein the sensor module is configured to be inserted into an insertion hole formed in the nut.

5. The bolting system according to claim 1,
wherein the sensor module is inserted into a sensing washer positioned between the nut and the workpiece,
wherein the sensing washer is configured to be in surface contact with the outer peripheral surface of the nut by a locking piece formed on the outer peripheral surface thereof such that the sensing washer is restrained to rotate together with the nut.

6. The bolting system according to claim 2,
wherein the second sensor module is provided to be finely adjusted in installation pressure by a pressure setting module,
wherein the pressure setting module comprises:
a pressure chamber which is formed to penetrate through the nut in the longitudinal direction of the bolt body and has a female screw formed on the inner circumferential surface thereof; and
an adjustment bolt which is inserted into the pressure chamber and screw-coupled to the female screw to facilitate pitch transfer,
wherein, after the bolt body and the nut are coupled to the workpiece, when the second sensor module is inserted into the pressure chamber and the adjustment bolt is screw-coupled into the pressure chamber, the second sensor module is pressed towards the workpiece by the pitch transfer of the adjustment bolt, so the initial zero-point pressure is finely adjusted.

7. A bolting system with a loosening detection function, comprising:
a bolt body inserted into a workpiece and having a bolt head formed at one end thereof;
nuts screw-screwed to both ends of the bolt body to fasten the workpiece; and
a sensor module positioned between the bolt head and the workpiece and between the nut and the workpiece to detect bolting information including fastening pressure and fastening position of the bolt head and the nuts,
wherein the sensor module has a small battery embedded for power supply and is configured to perform pairing (wireless communication) with a control unit including a terminal and a server by a communication module.

8. The bolting system according to claim 7,
wherein the sensor module comprises:
a first sensor module which detects positional movement due to the loosening of one or more of the bolt body and the nut; and
a second sensor module which detects vibration or pressure applied to one or more of the bolt body and the nut,
wherein the first sensor module is configured to set the initial position firmly fastened to the workpiece by the bolt body and the nut as the zero point, and based on the zero point, detects positional movement values according to the loosening of the one or more of the bolt body and the nut, thereby numerically calculating and visually outputting the loosening distance of the bolt body and the nut.

9. The bolting system according to claim 8,
wherein the sensor module calculates vibration or pressure values under conditions that cause loosening of the bolt body and the nut by matching the second sensor module's vibration or pressure detection values with the first sensor module's positional movement displacement values due to the loosening,
wherein the sensor module predicts the loosening of the bolt body and the nut based on the vibration or pressure detection values of the second sensor module.

10. The bolting system according to claim 8,
wherein the sensor module is configured to be inserted into an insertion hole formed in the nut or the bolt head.

11. The bolting system according to claim 7,
wherein the sensor module is inserted into a sensing washer positioned between the nut and the workpiece or between the bolt head and the workpiece,
wherein the sensing washer is configured to be in surface contact with the outer peripheral surface of the bolt head or the nut by a locking piece formed on the outer peripheral surface thereof such that the sensing washer is restrained to rotate together with the bolt head or the nut.

12. The bolting system according to claim 8,
wherein the second sensor module is provided to be finely adjusted in installation pressure by a pressure setting module,
wherein the pressure setting module comprises:
a pressure chamber which is formed to penetrate through the bolt head or the nut in the longitudinal direction of the bolt body and has a female screw formed on the inner circumferential surface thereof; and
an adjustment bolt which is inserted into the pressure chamber and screw-coupled to the female screw to facilitate pitch transfer,
wherein after the bolt body and the nut are coupled to the workpiece, when the second sensor module is inserted into the pressure chamber and the adjustment bolt is screw-coupled into the pressure chamber, the second sensor module is pressed towards the workpiece by the pitch transfer of the adjustment bolt, so the initial zero-point pressure is finely adjusted.
